(19) United States
(12) Patent Application Publication
(10) Pub. No.: US 2009/0003433 A1
(43) Pub. Date: Jan. 1, 2009

(54) TRANSCODER AND TRANSCODING METHOD

(75) Inventor: Tomonori HONJO, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki-shi (JP)

(21) Appl. No.: 12/140,408

(22) Filed: Jun. 17, 2008

(30) Foreign Application Priority Data
Jun. 27, 2007 (JP) 2007-168851

(51) Int. Cl. H04N 7/26

(52) U.S. Cl. 375/240.01; 375/E07.198

(57) ABSTRACT

A transcoder has been disclosed, which does not produce extra high frequency components or lower the compression rate even when the size of a decoded image is changed and the boundaries of macro blocks at the time of decoding and the boundaries of macro blocks at the time of re-encoding do not match each other. The transcoder comprises: a decoder that decodes image data encoded in a first format and outputs a decoded image; and an encoder that re-encodes the decoded image data into a second format, and further comprising: a scaler that changes the size of the decoded image; and a filter that carries out filtering processing for reducing high frequency components for pixels in the vicinity of the boundaries of macro blocks of the decoder in the decoded image, which do not match the boundaries of macro blocks of the encoder before or after the size is changed.

### CROSS-REFERENCE TO RELATED APPLICATION

This application is based upon and claims the benefit of priority from prior Japanese Patent Application No. 2007-168851, filed on Jun. 27, 2007, the entire contents of which are incorporated herein by reference.

### BACKGROUND

1. Field

The present application relates to a transcoder and a transcoding method.

2. Description of the Related Art

The transition from analog broadcast to digital broadcast, such as BS digital broadcast and ground wave digital broadcast, is under way.

In a digital broadcast, a compression system that utilizes correlation between images, such as MPEG2, is used as a motion image compression format. Currently, in a digital broadcast, data is transmitted at ten and some Mbs to twenty and some Mbs. A storage device, such as an HDD recorder, stores the digital data of the digital broadcast signal as it is or stores it by re-encoding (transcoding) the decoded image so that the compression rate is increased after decoding the digital data of the digital broadcast signal, i.e., it stores it after reducing the amount of data by encoding again with a lower bit rate than the bit rate of the original image. Reduction in the amount of data leads to an increase in the length of recording time. A device used for re-encoding is referred to as a transcoder.

FIG. 1 is a diagram showing a configuration of a transcoder 1. As shown schematically, transcoder 1 has a decoder 2 that decodes an input data stream encoded in a first format and outputs a decoded image, a post-processing part 3 that carries out post-processing of the decoded image output from decoder 2, a scaler 4 that carries out size changing processing for changing the size of the decoded image, a pre-processing part 5 that carries out pre-processing for encoding the decoded image having been subjected to the size changing processing, and an encoder 6 that re-encodes the decoded image having been subjected to the pre-processing. The first encoding format and the second encoding format may be any format, respectively. However, MPEG2 is widely used as the first encoding format and H.264 as the second encoding format, etc. There may be a case where the first and second encoding formats are both MPEG2 and data is transcoded so that the compression rate is increased. When the size is not changed, the processing of scaler 4 is not carried out. When the decoded image is displayed, the output of post-processing part 3 is output as a display output.

An input data stream is, for example, a signal read from a digital broadcast signal, an HDD recorder, etc. An output data stream is, for example, stored in an HDD recorder etc., and transmitted.

There may be a case where the entire transcoder 1 in FIG. 1 is put into an LSI, or a case where decoder 2 and encoder (transcoder) 3 are constituted by different LSIs, respectively, or a case where a temporary storage device, such as a DRAM, is added.

As shown in FIG. 1, when transcoding, the amount of data of a decoded image, which is a decoded input data stream, is reduced by changing (reducing) the image size etc., and due to this it is possible to record with an HDD recorder for a long period of time.

The processing in decoder 2 and encoder 6 is carried out in units of macro blocks by dividing a screen into macro blocks. In the case of MPEG2 and H.264, a macro block has 16×16, i.e., 256 pixels. Because the processing is carried out in units of macro blocks, there may be a case where a difference in concentration is produced at the boundary with its adjoining macro block. For example, when image data, of which the gradation part where its image node gradually changes is encoded, is decoded and played back, the concentration differs between macro blocks and the boundary of macro blocks becomes conspicuous.

In order to solve such a problem, in the H.264 format, as one kind of encoding processing, processing for making the boundary of macro blocks inconspicuous, called deblocking processing, is carried out. When encoder 6 is an H.264 encoder, there is a process in which a decoded image is stored in a frame memory by local decoding processing for a predicted image and deblocking filtering processing for reducing high frequency components resulting from the boundary of macro blocks is carried out adaptively immediately before the process. The deblocking filtering processing can be carried out at the boundary of a macro block having 16×16 pixels and in units of blocks having 4×4 or 8×8 pixels and in an H.264 main profile, the deblocking filtering processing can be carried out in units of blocks having 16×16 or 4×4 pixels and in an H.264 high profile, in units of blocks having 16×16, 8×8, or 4×4 pixels.

A transcoder is described in JP2004-512784A, JP2006-237759A, JP2004-23670A, etc.

JP2004-512784A describes a method of transcoding a primary encoded signal including a series of images into a secondary encoded signal and also describes a transcoding method using an embedded filter, further comprising a filtering step for obtaining excellent image quality for low-bit-rate applications.

JP2006-237759A describes a motion image re-encoding method for outputting an image immediately before filtering processing in loop at the decoding part when decoding and re-encoding an encoded stream of a motion image and re-encoding the image while taking over all of the encoding parameters in the previous stage or taking over almost all of them.

JP2004-23670A describes an image encoding apparatus, in which an input image control circuit determines the characteristics of the picture configuration of an input image and an image resolution changing circuit carries out filtering processing based on the determination so that the input image has a predetermined input resolution.

FIG. 2A to FIG. 2D are diagrams explaining size changing processing for reducing the size of a decoded image to ⅔ in the lateral (horizontal) direction. FIG. 2A shows macro blocks MA1 to MA9 of decoder 2 in the decoded image. Macro blocks MA1 to MA9 include 16×16, (256 pixels). In other words, in decoder 2, the processing is carried out in units of macro blocks MA1 to MA9 and a decoded image is generated. FIG. 2B shows macro blocks MB1 to MB9 of encoder 6 for the decoded image. Macro blocks MB1 to MB9 also include 16×16, (256 pixels). In other words, encoder 6 carries out the processing in units of macro blocks MB1 to MB9 for the decoded image. FIG. 2C shows macro blocks MA1 to MA9 when the decoded image is reduced.

When the size is not changed at the time of transcoding, i.e., when scaler 4 does not change the size, macro blocks MA1 to MA9 of decoder 2 and macro block MB1 to MB9 of encoder 6 match each other, and therefore, the noise (block noise) resulting from the boundaries of macro blocks MA1 to MA9 of decoder 2 does not affect the processing in units of macro blocks MB1 to MB9 in encoder 6. In particular, when encoder 6 is an H.264 encoder, because the above-mentioned deblocking processing is carried out as one of the encoding processing, there is no influence of the block noise. In other words, there exist no extra high frequency components resulting from the boundary in macro blocks MB1 to MB9, which are units of encoding processing.

However, when the size of the decoded image is changed to ⅔ in the lateral (horizontal) direction as shown in FIG. 2C, macro blocks MA1 to MA9 change to macro blocks MA1′ to MA9′ and as a result, part of the boundary in the longitudinal (vertical) direction exists within macro blocks MB1 to MB9. FIG. 2D shows a state where the boundary of macro blocks MA5′ and MA6′ exists in macro block MB5 of encoder 6. Because of this, the block noise of the boundary of MA5′ and MA6′ produces extra high frequency components within macro block MB5, which are units of encoding processing. In macro blocks other than MB5, the boundary exists similarly and extra high frequency components are produced. If such extra high frequency components exist, an extra amount of information (amount of data) is used for the compressing processing in units of macro blocks during the encoding processing and a problem arises in that the compression rate is reduced.

### SUMMARY

The embodiment provides a transcoder including a decoder that decodes image data encoded by a first format and outputs a decoded image, an encoder that re-encodes the decoded image data into a second format, a scaler that changes a size of the decoded image, and a filter that carries out filtering processing which reduces high frequency components for pixels in a vicinity of boundaries of macro blocks of the decoder in the decoded image, the boundaries of macro blocks of the decoder which do not match boundaries of macro blocks of the encoder, before or after the size is changed.

### BRIEF DESCRIPTION OF THE DRAWINGS

The features and advantages of embodiments of the present application will be more clearly understood from the following description taken in conjunction with accompanying drawings, in which:

FIG. 1 is a diagram showing a configuration of a conventional transcoder;

FIG. 2A to FIG. 2D are diagrams explaining size changing processing;

FIG. 3 is a diagram showing a configuration of a transcoder in an embodiment:

FIG. 4A and FIG. 4B are diagrams explaining a filter in the lateral (horizontal) direction and filtering processing in an embodiment;

FIG. 5 is a diagram explaining the application position of a filter in an embodiment;

FIG. 6 is a diagram explaining processing when the size is changed in the lateral (horizontal) direction;

FIG. 7 is a diagram explaining processing when the size is changed in the longitudinal (vertical) direction; and

FIG. 8 is a diagram explaining processing when the size is changed both in the lateral (horizontal) direction and in the longitudinal (vertical) direction.

### DESCRIPTION OF THE PREFERRED EMBODIMENTS

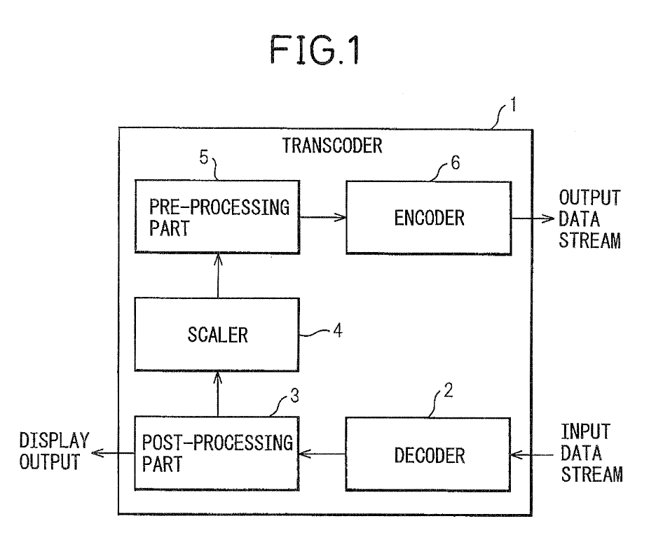

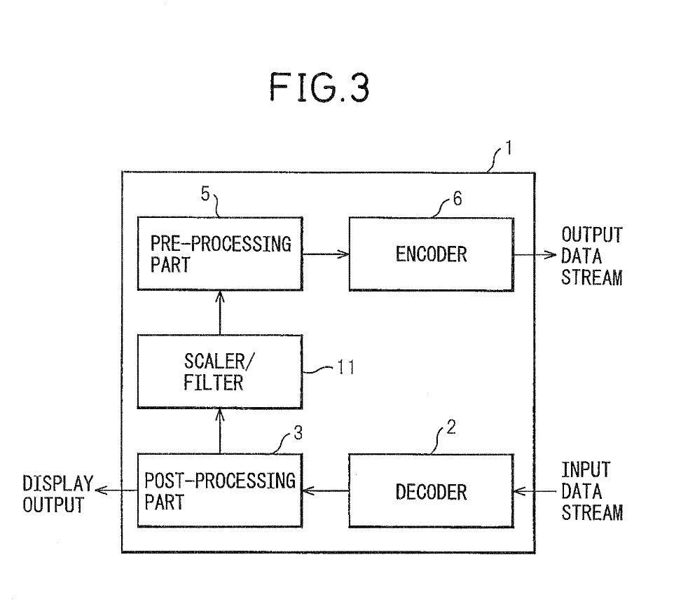

FIG. 3 is a diagram showing the configuration of transcoder 1 in the embodiment. As is obvious from comparison with FIG. 1, transcoder 1 in the embodiment differs from the conventional transcoder in that a scaler/filter 11 to which a filtering processing function has been added is provided in place of scaler 4 and other parts are the same as those in the conventional example in FIG. 1. In the present embodiment, it is assumed that the input data stream is MPEG2 data, decoder 2 is an MPEG2 decoder, and encoder 6 is an H.264 encoder.

Scaler/filter 11 has a filtering function of reducing the block noise of the boundaries of macro blocks at the time decoding that do not match the boundaries of macro blocks at the time of re-encoding in addition to the conventional scaling function of carrying out size changing processing. The filtering function is implemented by a filter in the lateral (horizontal) direction and a filter in the longitudinal (vertical) direction.

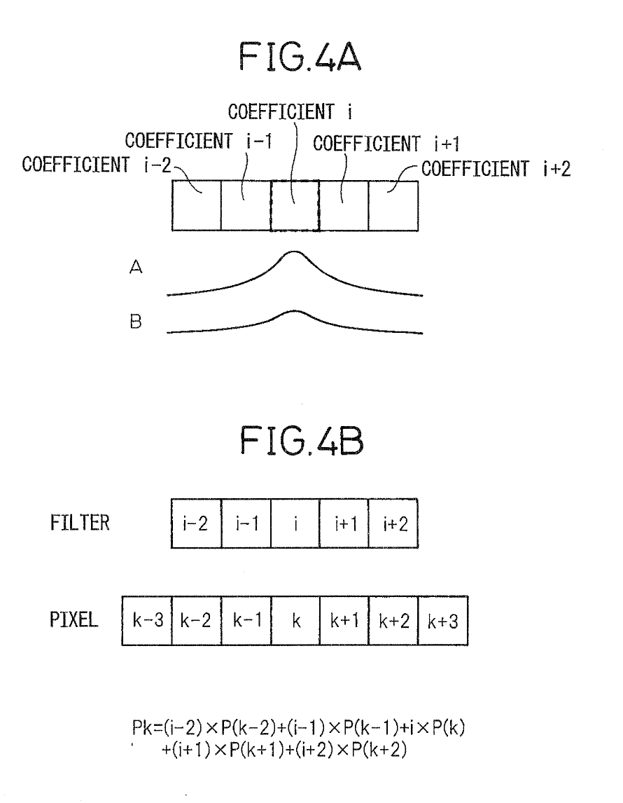

FIG. 4A and FIG. 4B are explanatory diagrams of the filter in the lateral direction. As shown in FIG. 4A, the filter in the lateral direction is a filter that carries out operation on the pixel values of a plurality of pixels (here, five pixels, including the pixel to be processed) in one pixel row in the lateral direction. As shown in FIG. 4B, a pixel k in the pixel row in the lateral (horizontal) direction is an object to be processed and the sum of the values of the pixel values of the pixels k−2, k−1, k, k+1, k+2 in the pixel row in the lateral direction multiplied by filter coefficients i−2, i−1, i, i+1, i+2, respectively, is taken as a pixel value of the pixel to be processed. In other words, a pixel value Pk of a pixel to be processed is expressed by Pk=(i−2)×P(k−2)+(i−1)×P(k−1)+i×P(k)+(i+1)×P(k+1)+(i+2)×P(k+2). Each filter coefficient is a decimal fraction and is set so that (i−2)+(i−1)+i+(i+1)+(i+2)=1 holds.

As shown in FIG. 4A, filter coefficients i−2, i−1, i, i+1, i+2 may be switched to an A pattern or a B pattern. Patterns A and B are in a bilateral symmetry and the value at the center (coefficient i) is large and becomes smaller toward both end portions. In pattern A, the ratio between the coefficient at the center (coefficient i) and that at the end portion is large compared to that in pattern B, and the coefficient at the center is very large; however, the coefficient becomes rapidly smaller toward the end portion. In contrast to this, in pattern B, the ratio between the coefficient at the center (coefficient i) and that at the end portion is small.

The configuration of the filter in the longitudinal (vertical) direction is the configuration of the filter in the lateral direction rotated through 90 degrees. In other words, the filter in the longitudinal direction has the same configuration as the filter in the lateral direction, except the direction is longitudinal.

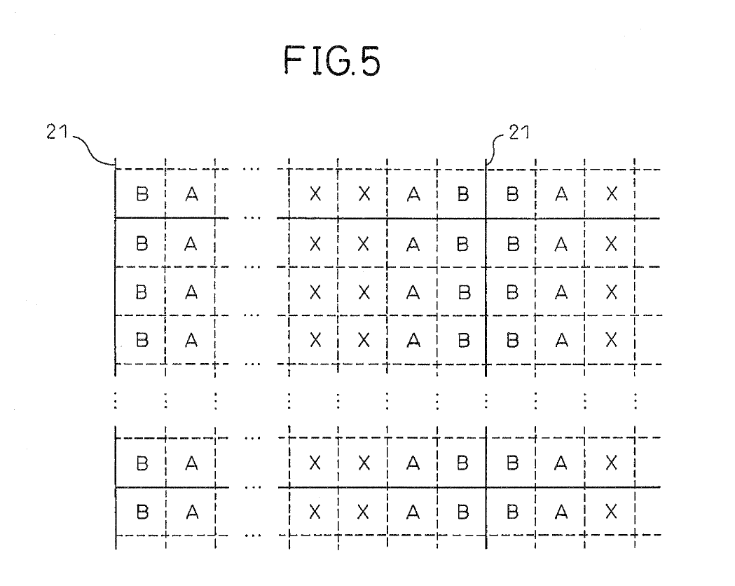

FIG. 5 is a diagram explaining the position at which the filtering operation is applied. In FIG. 5, it is assumed that lines 21 in the longitudinal direction are the boundaries of macro blocks at the time of decoding in a decoded image, which do not match the boundaries of macro blocks at the time of re-encoding. In the present embodiment, a total of four pixels, i.e., two pixels on both ends of the boundary, respectively, are subjected to the filtering processing by the filter in the lateral direction in FIG. 4A and FIG. 4B. As shown in FIG. 5, the pixels directly adjoining the boundary are subjected to the filtering processing by the filter in the lateral direction having coefficients in pattern B in FIG. 4A and FIG. 4B and the pixels adjoining these pixels are subjected to the filtering processing by the filter in the lateral direction having coefficient in pattern A in FIG. 4A and FIG. 4B. In FIG. 5, the pixels to which pattern B is applied are denoted by B, those to which pattern A is applied are denoted by A, and those to which the filtering processing is not applied are denoted by ×.

When the pixels denoted by B to the left of the boundary are subjected to the filtering processing by the filter in the lateral direction, the pixel denoted by B is regarded as a pixel to be processed and its pixel value is multiplied by coefficient i, the pixel value of the pixel denoted by A to the left thereof is multiplied by coefficient i−1, and the pixel value of the pixel denoted by × further to the left thereof is multiplied by i−2, and the pixel value of the pixel denoted by B to the right of the pixel to be processed is multiplied by coefficient i+1 and the pixel value of the pixel denoted by A further to the right thereof is multiplied by coefficient i+2, and the sum of the pixel values multiplied by the respective coefficients is taken as the pixel value of the pixel to be processed.

In the case of the filter in the longitudinal direction, at the boundaries of macro blocks in the longitudinal direction at the time of decoding in the decoded image, which do not match the boundaries of macro blocks at the time of re-encoding, the same method in FIG. 5 is applied.

The filtering processing may be carried out before the size of the decoded image is changed or after the size is changed.

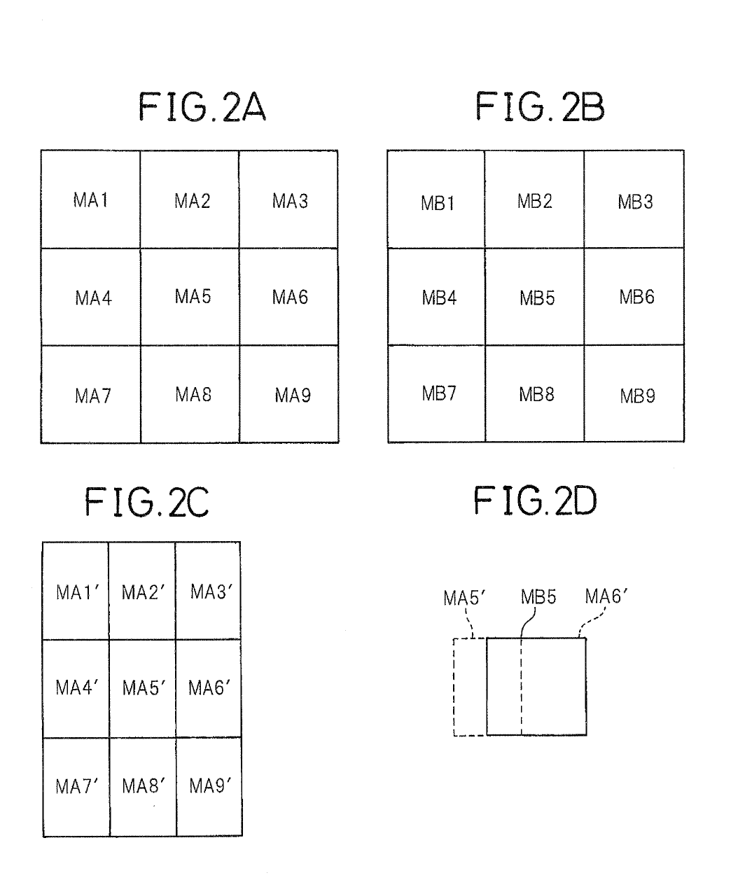

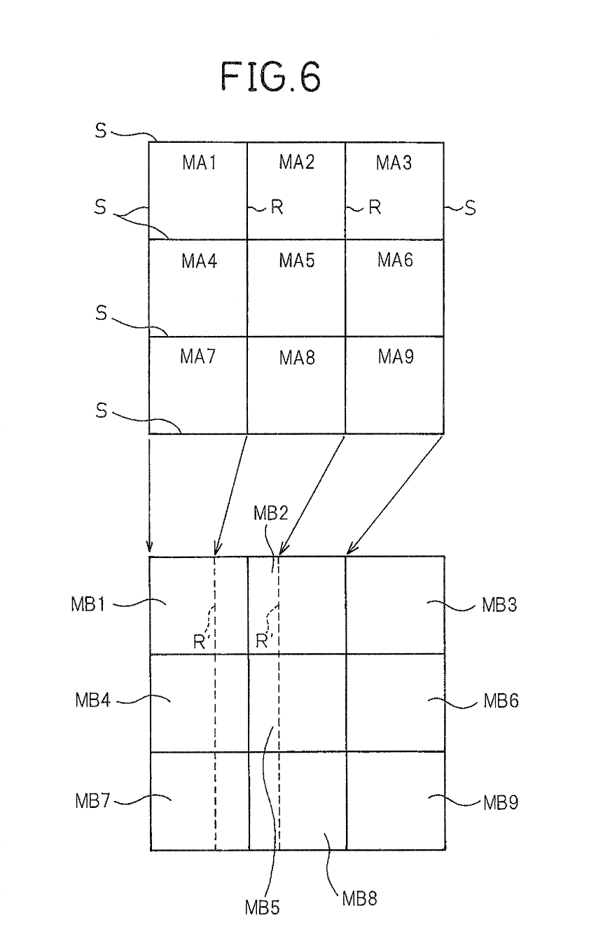

FIG. 6 shows an embodiment in case that the size of the decoded image shown in FIG. 2A is reduced to ⅔ in the lateral (horizontal) direction. As shown in FIG. 6, when the size is reduced to ⅔ in the lateral (horizontal) direction, the boundaries denoted by R among the boundaries of macro blocks MA1 to MA9 at the time of decoding in the decoded image do not match any longer the boundaries of macro blocks MB1 to MB9 at the time of re-encoding as shown schematically. However, the boundaries denoted by S in the lateral (horizontal) direction and the longitudinal boundaries on the leftmost end match each other.

When the filtering processing is carried out before the size is changed, the boundaries denoted by R in the figure on the upper side are subjected to the filtering processing explained in FIG. 4 and FIG. 5. In the case of 16×16 macro blocks, because the number of pixels of the boundary in the lateral direction is a multiple of 16, the pixels with the pixel numbers j=16n−1, 16n+2 (macro block number n=1, 2, . . . , n−1) in the lateral direction are subjected to the filtering processing with pattern A, the pixels with the pixel numbers j=16n, 16n+1, (macro block number n=1, 2, . . . , n−1) in the lateral direction are subjected to the filtering processing with pattern B, and other pixels are not subjected to the filtering processing.

When the filtering processing is carried out after the size is changed, the boundaries in the longitudinal direction denoted by R′ and shown by the dashed lines in the figure on the lower side are subjected to the filtering processing explained in FIG. 4A, FIG. 4B, and FIG. 5. In FIG. 6, the boundaries of macro blocks in the lateral direction match at the leftmost end and exist in the eleventh pixel and the twenty-second pixel, and therefore, the filtering processing is applied to the four pixels including these pixels. For example, in the case of the pixels in which the boundary of macro blocks exists and where the boundary is to the left of the center of the pixel, the pixel is taken as a pixel on the right side of the boundary in FIG. 5 and when the boundary of macro blocks is to the right of the center of the pixel, the pixel is taken as a pixel on the left side of the boundary and the filter in FIG. 4A and FIG. 4B is applied. As a result, when the size is reduced to ⅔, the eleventh pixel is taken as a pixel on the right side of the boundary in FIG. 5 and the twenty-second pixel is taken as a pixel on the left side of the boundary. Afterward, this is repeated for every 32 pixels in the reduced image.

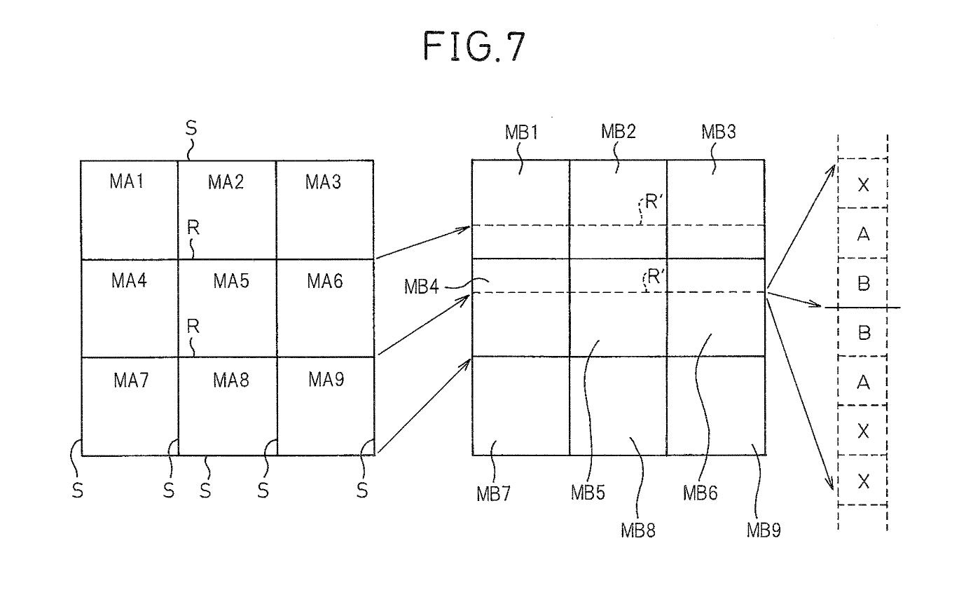

FIG. 7 shows an embodiment to which the present application has been applied when the size of the decoded image is reduced to ⅔ in the longitudinal (vertical) direction. As shown in FIG. 7, when the size is reduced to ⅔ in the longitudinal (vertical) direction, the boundaries denoted by R among the boundaries of macro blocks MA1 to MA9 at the time of decoding in the decoded image do not match any longer the boundaries of macro blocks MB1 to MB9 at the time of re-encoding as shown schematically. However, the boundaries denoted by S in the longitudinal (vertical) direction and the longitudinal boundaries on the uppermost end match each other.

When the filtering processing is carried out before the size is changed, the boundaries denoted by R in the figure on the left side are subjected to the filtering processing with the filter in the longitudinal (vertical) direction that carries out the filtering processing explained in FIG. 4 and FIG. 5 in the direction rotated through 90 degrees. The pixels with the pixel numbers k=16n−1, 16n+2 (macro block number n=1, 2, . . . , n−1) in the longitudinal direction are subjected to the filtering processing with pattern A, the pixels with the pixel numbers k=16n, 16n+1, (macro block number n=1, 2, . . . , n−1) are subjected to the filtering processing with pattern B, and other pixels are not subjected to the filtering processing.

When the filtering processing is carried out after the size is changed, the boundaries in the longitudinal direction denoted by R′ and shown by the dashed line in the figure on the right side are subjected to the filtering processing explained in FIG. 7.

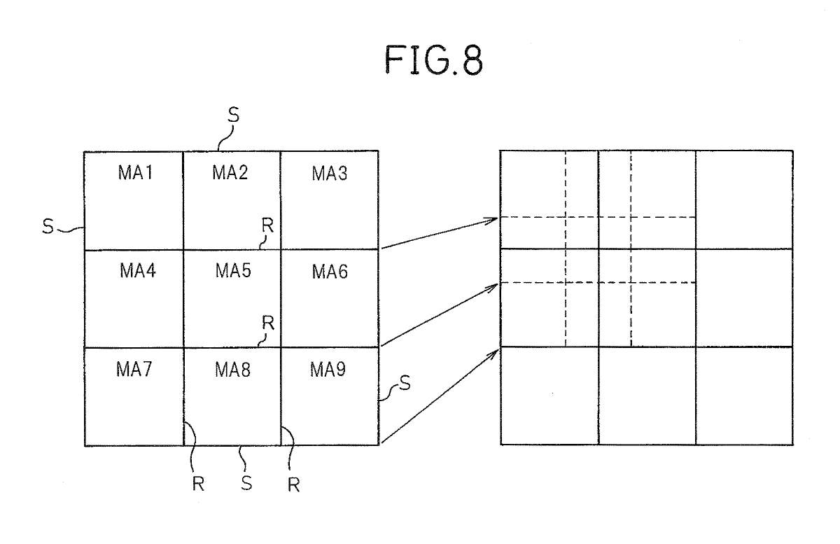

FIG. 8 shows an embodiment in case that the size of the decoded image is reduced to ⅔ both in the lateral (horizontal) direction and in the longitudinal (vertical) direction. As shown in FIG. 8, the boundaries of macro blocks MA1 to MA9 at the time of decoding in the decoded image do not match any longer the boundaries of macro blocks MB1 to MB9 at the time of re-encoding except for those denoted by S on the rightmost, leftmost, uppermost, and lowermost ends. Among the boundaries that do not math each other, the filter in the lateral (horizontal) direction is applied to the boundaries in the longitudinal (vertical) direction and the filter in the longitudinal (vertical) direction is applied to the boundaries in the lateral (horizontal) direction, respectively. The pixels in the corner portions are subjected to the filtering processing with one of the filters and then to the filtering processing with the other. The example in FIG. 8 is a combination of the examples in FIG. 6 and FIG. 7, and therefore, further explanation is omitted.

Although the embodiments are explained as above, the already-known processing is applied as it is for the processing, such as the decoding processing, the encoding processing, the pre-processing, the post-processing, and the size changing processing. For example, in the embodiments, an example is explained, in which the decoded image is reduced to ⅔. However, it is obvious that already known processing for changing the size to another size may be applied.

In the case where the size is changed to ¾, a 4×4 deblocking filter is effective for the edge that occurs in the macro block when the size is changed. However, it may be not effective for the 16×16 deblocking filtering processing and therefore the encoding efficiency may not be improved.

An object of the present application is to realize a transcoder that does not produce extra high frequency components or lower the compression rate even when the size of a decoded image is changed and the boundaries of macro blocks at the time of decoding and the boundaries of macro blocks at the time of re-encoding do not match each other.

In order to realize the above object, the transcoder according to the present application is characterized by comprising a filter that carries out filtering processing for reducing high frequency components before or after changing the size for pixels in the vicinity of the boundaries of macro blocks of the decoder, which do not match the boundaries of macro blocks of the encoder.

According to the present application, because the filtering processing for reducing extra high frequency components is carried out for pixels in the vicinity of the boundaries of macro blocks of the decoder, which do not match the boundaries of macro blocks of the encoder, i.e., the boundaries that produce extra high frequency components within the macro blocks to be subjected to the encoding processing, the compression rate is no longer likely to be lowered.

Aforementioned embodiment provides a filter in the lateral direction that generates a pixel value of a pixel to be processed by calculating the sum of the respective pixel values of a plurality of pixels before and after the pixel in one pixel row in the lateral direction multiplied by respective predetermined coefficients and a filter in the longitudinal direction that generates a pixel value of a pixel to be processed by calculating the sum of the respective pixel values of a plurality of pixels before and after the pixel in one pixel column in the longitudinal direction multiplied by respective predetermined coefficients, and the filter in the lateral direction is applied to the boundary in the longitudinal direction of the screen and the filter in the longitudinal direction is applied to the boundary in the lateral direction of the screen.

The filter carries out filtering processing for the pixels in the vicinity of the boundary, for example, for the two pixels on both sides of the boundary, respectively.

When the filter, such as that described above, is used, the predetermined coefficients of the filter in the lateral direction and the filter in the longitudinal direction are made different between the pixel near the boundary and the pixel distant from the boundary.

According to the present application, even when the size of a decoded image is changed and the boundaries of macro blocks at the time of decoding do not match the boundaries of macro blocks at the time of re-encoding, extra high frequency components resulting from the boundaries that do not math each other are reduced by filtering processing, and therefore, it may be possible to increase the compression rate of transcoding.

The present application can be applied to any configuration in which encoded image data is re-encoded after it is once decoded.

We claim:

1. A transcoder comprising:
a decoder that decodes image data encoded by a first format and outputs a decoded image; and
an encoder that re-encodes the decoded image data into a second format;
a scaler that changes a size of the decoded image; and
a filter that carries out filtering processing which reduces high frequency components for pixels in a vicinity of boundaries of macro blocks of the decoder in the decoded image, the boundaries of macro blocks of the decoder which do not match boundaries of macro blocks of the encoder, before or after the size is changed.

2. The transcoder according to claim 1, wherein the filter comprises:
a filter in the lateral direction that calculates the sum of pixel values of a plurality of pixels before and after a pixel to be processed in a pixel row in the lateral direction multiplied by predetermined coefficients, respectively, and takes it as a pixel value of the pixel to be processed;
a filter in the longitudinal direction that calculates the sum of pixel values of a plurality of pixels before and after a pixel to be processed in a pixel column in the longitudinal direction multiplied by predetermined coefficients, respectively, and takes it as a pixel value of the pixel to be processed,
wherein
the filter in the lateral direction is applied to the boundaries in the longitudinal direction in a screen and the filter in the longitudinal direction is applied to the boundaries in the lateral direction in the screen.

3. The transcoder according to claim 2, wherein the filter carries out filtering processing for two pixels on both sides of the boundary, respectively.

4. The transcoder according to claim 3, wherein the predetermined coefficients of the filter in the lateral direction and the filter in the longitudinal direction are made different between those for pixels near the boundary and those for pixels distant from the boundary.

5. A transcoding method comprising:
changing a size of a decoded image by decoding image data encoded in a first format; and
carrying out filtering processing for reducing high frequency components for pixels in the vicinity of boundaries of macro blocks of the decoder in the decoded image, the boundaries of macro blocks of the decoder which do not match boundaries of macro blocks of the re-encoder re-encoding the decoded image data into a second format, before or after the size is changed.

6. The transcoding method according to claim 5, wherein the filtering processing comprises: filtering processing in the lateral direction for calculating the sum of pixel values of a plurality of pixels before and after a pixel to be processed in a pixel row in the lateral direction multiplied by predetermined coefficients, respectively, and taking it as a pixel value of the pixel to be processed; and filtering processing in the longitudinal direction for calculating the sum of pixel values of a plurality of pixels before and after a pixel to be processed in a pixel column in the longitudinal direction multiplied by predetermined coefficients, respectively, and taking it as a pixel value of the pixel to be processed; and
the filtering processing in the lateral direction is applied to the boundaries in the longitudinal direction in a screen and the filtering processing in the longitudinal direction is applied to the boundaries in the lateral direction in the screen.

7. The transcoding method according to claim 6, wherein the filtering processing is carried out for two pixels on both sides of the boundary, respectively.

8. The transcoding method according to claim 7, wherein the predetermined coefficients of the filtering processing in the lateral direction and the filtering processing in the longitudinal direction are made different between those for pixels near the boundary and those for pixels distant from the boundary.
